(19) United States
(12) Patent Application Publication
(10) Pub. No.: US 2008/0241602 A1
(43) Pub. Date: Oct. 2, 2008

(54) MAGNETIC RECORDING MEDIUM AND PROCESS FOR PRODUCING THE SAME

(75) Inventors: Hiroyuki TANAKA, Tokyo (JP); Tsutomu IDE, Tokyo (JP); Osamu INOUE, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK Corporation, Tokyo (JP)

(21) Appl. No.: 12/056,592

(22) Filed: Mar. 27, 2008

(30) Foreign Application Priority Data
Mar. 30, 2007 (JP) 2007-095603

(51) Int. Cl. G11B 5/66; G11B 5/84

(52) U.S. Cl. 428/840.1; 427/128

(57) ABSTRACT

The present invention provides a magnetic recording medium wherein both of a reduction in the particle diameter of a ferromagnetic powder and an increase in the filling ratio of the powder in a magnetic layer are attained and the magnetic layer is excellent in surface smoothness and electromagnetic conversion property. A magnetic recording medium comprising at least a non-magnetic support, a lower non-magnetic layer on one surface of the non-magnetic support, and an upper magnetic layer on the lower non-magnetic layer, wherein the lower non-magnetic layer contains at least carbon black, a non-magnetic inorganic powder other than carbon black, and a binder resin, the upper magnetic layer contains at least a ferromagnetic powder and a binder resin containing a polar group, and the ferromagnetic powder is a ferromagnetic metal powder having an average major axis length of 10 to 50 nm, or a hexagonal ferrite magnetic powder having an average plate diameter of 5 to 40 nm, and the polar-group-containing binder resin is contained in the upper magnetic layer in such an amount that a proportion of said polar group to unit specific surface area based on the BET method of the ferromagnetic powder is set into a range of 0.18 to 0.35 μmol/m².

### BACKGROUND OF THE INVENTION

1. Field of the Invention

The present invention relates to a magnetic recording medium, and a process for producing the same, more specifically, a magnetic recording medium excellent in surface smoothness of the magnetic layer and electromagnetic conversion property, and a process for producing the same.

2. Disclosure of the Related Art

In recent years, the recording density of magnetic recording media has been desired to be made high in order to cope with an increase in the quantity of recording data. In particular, as for magnetic tapes used to record data into a computer, which are called LTO (registered trademark: Linear Tape Open), DLT (registered trademark: Digital Linear Tape) and other magnetic recording media, the recording density thereof has been desired to be made high. In order to make the recording density high, the recording wavelength is made shorter, the recording track width is narrower, and the magnetic layer is made thinner. From the viewpoint of an improvement in electromagnetic conversion property, a ferromagnetic powder is required to be made finer and the filling ratio of the powder into the magnetic layer is also required to be made higher. As the recording wavelength is made shorter, the magnetic layer surface is required to be made smoother from the viewpoint of spacing loss.

Japanese Patent No. 2700706 discloses a magnetic recording medium comprising a magnetic layer containing a ferromagnetic alloy powder and a binder, wherein: the major axis length of the ferromagnetic alloy powder is 2000 Å or less; the saturation magnetization (σs) of the powder is 100 emu/g or more; the binder contains a polyurethane resin having 3 or more hydroxyl groups per molecule, and 1×10⁻⁵ eq/g or more of polar group(s) selected from —SO₃M, —OSO₃M, —COOM, —PO(OM′)₂, and —OPO(OM′)₂ wherein M and M′ each represent hydrogen, an alkali metal or ammonium, in an amount of the polyurethane being equal to or more than the amount of polyisocyanate; and the binder further contains a vinyl chloride copolymer having one or more polar groups in an amount of 1×10⁻⁵ eq/g or more, the polar group(s) being selected from —SO₃M, —OSO₃M, —COOM, —PO(OM′), and —OPO(OM′)₂ wherein M and M′ each represent hydrogen, an alkali metal or ammonium (Claim).

Japanese Laid-Open Patent Publication No. 2003-59028 discloses a magnetic recording medium comprising a magnetic layer containing a ferromagnetic powder and a binder, wherein: the ferromagnetic powder is a ferromagnetic metal powder having an average major axis length of 10 to 80 nm and a crystallite size of 8 to 18 nm, or a ferromagnetic hexagonal ferrite powder having an average plate diameter of 5 to 40 nm; and the binder contains at least one polar group selected from —SO₃M, —OSO₃M, —PO(OM′)₂, —OPO(OM′)₂ and —COOM, wherein M represents hydrogen, an alkali metal or an ammonium salt, in an amount of 0.2 to 0.7 meq/g, and/or at least one polar group selected from —CONR₁R₂, —NR₁R₂ and —NR₁R₂R₃⁺, wherein R₁, R₂ and R₃ each independently represent a hydrogen atom or an alkyl group, in an amount of 0.5 to 5 meq/g (Claim).

Japanese Laid-Open Patent Publication No. 2005-149621 discloses a magnetic recording medium comprising, on one surface of a non-magnetic support, a non-magnetic layer containing a non-magnetic powder and a binder resin, and a magnetic layer containing a ferromagnetic metal powder and a binder resin, wherein: the average major axis length of the ferromagnetic metal powder is 80 nm or less; the three-dimensional center plane average roughness of a 100 μm² region in the surface of the magnetic layer, measured with an atomic force microscope, is 3.0 nm or less; and the occupation area of irregularities having a height of ±5.0 nm or more from the average height face in the 100 μm² region in the surface of the magnetic layer, measured with the atomic force microscope, is 15% or less (Claim).

Japanese Laid-Open Patent Publication No. 2005-149622 discloses a magnetic recording medium comprising, on one surface of a non-magnetic support, a non-magnetic layer containing a non-magnetic powder and a binder resin, and a magnetic layer containing a hexagonal ferrite magnetic powder and a binder resin, wherein: the average plate diameter of the hexagonal ferrite magnetic powder is from 10 to 40 nm; the three-dimensional center plane average roughness of a 100 μm² region in the surface of the magnetic layer, measured with an atomic force microscope, is 3.0 nm or less; and the occupation area of irregularities having a height of ±5.0 nm or more from the average height face in the 100 μm² region in the surface of the magnetic layer, measured with the atomic force microscope, is 15% or less (Claim).

### SUMMARY OF THE INVENTION

As described above, from the viewpoint of an improvement in electromagnetic conversion property, a ferromagnetic powder is required to be made finer, and the filler content of the ferromagnetic powder into the magnetic layer is also required to be made higher. However, as the ferromagnetic powder is made finer, the specific surface area thereof becomes larger. Thus, in order to disperse the ferromagnetic powder uniformly, a larger amount of a binder resin is required. In other words, the ratio by weight of the ferromagnetic powder P and the binder resin B (the weight ratio P/B) in the magnetic layer coating material lowers. For this reason, the filling ratio of the ferromagnetic powder in the magnetic layer [the filling ratio=the weight of the ferromagnetic powder present in unit volume (g/cm³) in the magnetic layer] lowers. In this manner, a tradeoff relationship lies between a reduction in the particle diameter of the ferromagnetic powder and an increase in the filling ratio of the powder in the magnetic layer.

An object of the present invention is to provide a magnetic recording medium wherein both of a reduction in the particle diameter of a ferromagnetic powder and an increase in the filling ratio of the powder in a magnetic layer are attained and the magnetic layer is excellent in surface smoothness and electromagnetic conversion property.

The present inventors have found out that by use of a polar-group-containing binder resin in a magnetic layer to set the number of the polar groups per unit specific surface area of the fine ferromagnetic powder into a specified range, the ferromagnetic powder can be uniformly dispersed without lowering the ratio by weight of the ferromagnetic powder P to the binder resin B (the weight ratio P/B) in a magnetic layer coating material, so that the filling ratio of the ferromagnetic powder in the magnetic layer can be made high.

The present invention comprises the followings:

(1) A magnetic recording medium comprising at least a non-magnetic support, a lower non-magnetic layer on one surface of the non-magnetic support, and an upper magnetic layer on the lower non-magnetic layer,

wherein the lower non-magnetic layer contains at least carbon black, a non-magnetic inorganic powder other than carbon black, and a binder resin,

the upper magnetic layer contains at least a ferromagnetic powder and a binder resin containing a polar group, and

the ferromagnetic powder is a ferromagnetic metal powder having an average major axis length of 10 to 50 nm, or a hexagonal ferrite magnetic powder having an average plate diameter of 5 to 40 nm, and

the polar-group-containing binder resin is contained in the upper magnetic layer in such an amount that a proportion of said polar group to unit specific surface area based on the BET method of the ferromagnetic powder is set into a range of 0.18 to 0.35 μmol/m².

(2) The magnetic recording medium according to above-described (1), wherein the specific surface area based on the BET method of the ferromagnetic powder is from 60 to 100 m²/g.

(3) The magnetic recording medium according to above-described (1) or (2), wherein, in the upper magnetic layer, the polar group of the polar-group-containing binder resin is contained in a proportion of 40 to 150 eq/ton on the basis of the mass of a whole binder resin material in the upper magnetic layer.

(4) The magnetic recording medium according to any one of above-described (1) to (3), wherein the upper magnetic layer has a thickness of 0.30 μm or less.

(5) The magnetic recording medium according to any one of above-described (1) to (4), wherein the binder resin contained in the lower non-magnetic layer is a cured product of an electron beam curable resin.

(6) The magnetic recording medium according to any one of above-described (1) to (5), wherein the lower non-magnetic layer has a thickness of 0.3 μm or more and 2.5 μm or less.

(7) The magnetic recording medium according to any one of above-described (1) to (6), which comprises, on the other surface of the non-magnetic support, aback coat layer containing at least carbon black, a non-magnetic inorganic powder other than carbon black, and a binder resin.

(8) The magnetic recording medium according to any one of above-described (1) to (7), which is used in a magnetic recording/reproducing system wherein reproduction is attained by means of a magneto resistive head (MR head).

(9) A process for producing a magnetic recording medium comprising at least a non-magnetic support, a lower non-magnetic layer on one surface of the non-magnetic support, and an upper magnetic layer on the lower non-magnetic layer, the process comprising the steps of:

applying, onto one surface of a non-magnetic support, a non-magnetic layer coating material which contains at least carbon black, a non-magnetic inorganic powder other than carbon black, and a binder resin material, thereby forming a lower non-magnetic layer; and

applying, onto the lower non-magnetic layer, a magnetic layer coating material which contains at least a ferromagnetic powder, and a binder resin containing a polar group wherein the ferromagnetic powder is a ferromagnetic metal powder having an average major axis length of 10 to 50 nm, or a hexagonal ferrite magnetic powder having an average plate diameter of 5 to 40 nm, and the polar-group-containing binder resin is contained in such an amount that a proportion of said polar group to unit specific surface area based on the BET method of the ferromagnetic powder is set into a range of 0.18 to 0.35 μmol/m², and drying the resultant, thereby forming an upper magnetic layer.

According to the present invention, the ferromagnetic powder contained in the upper magnetic layer is a ferromagnetic metal powder having an average major axis length of 10 to 50 nm, or a hexagonal ferrite magnetic powder having an average plate diameter of 5 to 40 nm, and the binder resin containing the polar group in the upper magnetic layer is contained in such an amount that the amount of the polar group is set to a specified value in the range of 0.18 to 0.35 μmol/m² per unit specific surface area (based on the BET method) of the ferromagnetic powder; therefore, in spite of the use of the fine ferromagnetic powder, the ferromagnetic powder can be uniformly dispersed without lowering the ratio by weight of the ferromagnetic powder P to the binder resin B (the weight ratio P/B) in a magnetic layer coating material. As a result, the filling ratio of the ferromagnetic powder in the magnetic layer can be made high. In such away, both of a reduction in the size of the ferromagnetic powder and an increase in the filling ratio of the powder in the magnetic layer are attained, so as to provide a magnetic recording medium excellent in the surface smoothness and electromagnetic conversion property of the magnetic layer.

### DETAILED DESCRIPTION OF THE INVENTION

The magnetic recording medium of the present invention comprises at least a non-magnetic support, a lower non-magnetic layer on one surface of the non-magnetic support, and an upper magnetic layer on the lower non-magnetic layer, and commonly comprises a back coat layer on the other surface of the non-magnetic support. The lower non-magnetic layer has a thickness of, for example, 0.3 to 2.5 μm, the upper magnetic layer has a thickness of, for example, 0.30 μm or less, preferably 0.03 to 0.30 μm, and the back coat layer has a thickness of, for example, 0.3 to 0.8 μm. The total thickness of the magnetic recording medium is preferably from 4.0 to 7.0 μm. A lubricant coating layer, various coating layers for protecting the magnetic layer, and the like may be formed on the upper magnetic layer if necessary. An undercoat layer (adhesive layer) may be formed on the one surface of the non-magnetic support on which the magnetic layer is to be formed, in order to attain an improvement in the adhesive property between the lower non-magnetic layer and the non-magnetic support, and other effects. In this case, the thickness of the undercoat layer is preferably from 0.05 to 0.30 μm. In order that the adhesive property improvement and the other effects can be expressed, the thickness of the undercoat layer is preferably 0.05 μm or more. When the thickness is 0.05 μm or more and 0.30 μm or less, these effects become sufficient.

### [Upper Magnetic Layer]

The upper magnetic layer contains at least a ferromagnetic powder, and a binder resin containing a polar group species.

In the present invention, the ferromagnetic powder contained in the upper magnetic layer is a ferromagnetic metal powder having an average major axis length of 10 to 50 nm, or a hexagonal ferrite magnetic powder having an average plate diameter of 5 to 40 nm. By using an appropriate amount of a binder resin to disperse such a ferromagnetic powder having a fine size uniformly, the filling ratio of the ferromagnetic powder in the magnetic layer [the weight of the ferromagnetic powder present in any unit volume (g/cm³) in the magnetic layer] can be made high and further the surface smoothness of the magnetic layer can be made excellent. Conventionally, such a fine-size ferromagnetic powder is generally poor in dispersibility; thus, in order to disperse the powder uniformly, it is necessary to use a large amount of a binder resin. As a result, a high filling ratio of the powder cannot be obtained. In the present invention, by use of the polar-group-containing binder resin to set the number of the polar groups per unit specific surface area of the ferromagnetic powder into a specified range, the fine-size ferromagnetic powder can be uniformly dispersed without lowering the ratio by weight of the ferromagnetic powder P to the binder resin B (the weight ratio P/B) in a magnetic layer coating material, as will be demonstrated later. As a result, the obtained magnetic layer is a layer having a high filling ratio of the ferromagnetic powder and an excellent surface smoothness. Thus, the electromagnetic conversion property can be improved.

The average major axis length of the ferromagnetic metal powder is from 10 to 50 nm, preferably from 20 to 45 nm. If the average major axis length of the ferromagnetic metal powder is more than 50 nm, the filling ratio of the ferromagnetic powder in the magnetic layer cannot be made high. If the average major axis length is less than 10 nm, the magnetic anisotropy of the ferromagnetic metal powder becomes weak so that the powder is not easily oriented. Thus, the magnetic property (output) lowers. The average minor axis length of the ferromagnetic metal powder is preferably from 2 to 20 nm, more preferably from 5 to 15 nm. The aspect ratio is preferably from 2 to 10, more preferably from 3 to 7. The average major axis length and the average minor axis length are usually measured with a transmission electron microscope.

The average major axis length, the average minor axis length, and the aspect ratio of the ferromagnetic powder can be adjusted, considering the concentration of a liquid when a precursor of the ferromagnetic powder is produced, the procedure of adding the liquid, the pH, and time for stirring the liquid; the temperature when additive elements are adhered to the precursor powder, and the pH, the concentration of the liquid, and thermal treatment conditions at the time; the kind and amount of the additive elements; and the calcining temperature of the precursor, the calcining time, the calcining atmosphere, the rate of temperature rise, and other conditions.

As the size of the ferromagnetic powder becomes smaller, the specific area generally becomes larger; the specific surface area of the ferromagnetic metal powder, based on the BET method, is preferably from 60 to 100 m²/g, more preferably from 65 to 100 m²/g, even more preferably from 70 to 100 m²/g. If the specific surface area of the ferromagnetic metal powder, based on the BET method, is more than 100 m²/g, the powder turns into the form that irregularities are present in the surface so that the dispersibility in the magnetic coating material falls easily. If the specific surface area is less than 60 m²/g, the powder aggregates easily so that the dispersibility in the magnetic coating material falls easily. The specific surface area of the ferromagnetic powder can be adjusted, considering the same conditions as in the method of adjusting the average major axis length of the ferromagnetic powder.

The coercive force Hc of the ferromagnetic metal powder is preferably 118.5 to 278.5 kA/m (1500 to 3500 Oe), and the saturation magnetization σs is preferably from 70 to 160 Am²/kg (emu/g). The Hc of the medium formed by use of the ferromagnetic metal powder is preferably from 118.5 to 278.5 kA/m (1500 to 3500 Oe).

The ferromagnetic metal powder is not particularly limited, and is preferably a metal powder made mainly of α-Fe. The ferromagnetic metal powder may be doped with Ni, Co, Al, Si, a rare earth element, or the like. The content of such a metal element in the ferromagnetic metal powder is as follows, the content being represented by the ratio of the mass of the doping metal element to the mass of Fe regarded as 100: Ni=0.3 to 8.0, Co=3.0 to 45.0, Al=0.5 to 8.0, Si=0.5 to 8.0, and a rare earth element=0.2 to 10.0 provided that Al+Si=2.0 to 15.0. The rare earth metal is selected from La, Ce, Pr, Nd, Sm, Gd, Dy, and Y.

The average plate diameter of the hexagonal ferrite powder is from 5 to 40 nm, preferably from 10 to 25 nm. If the average plate diameter of the hexagonal ferrite powder is more than 40 nm, the filling ratio of the hexagonal ferrite powder in the magnetic layer cannot be made high. If the average plate diameter is less than 5 nm, the hexagonal ferrite powder becomes weak in magnetic anisotropy not to be easily oriented so that the magnetic property (reproducing output) lowers. The plate ratio of the hexagonal ferrite powder is preferably from 2 to 7. The average plate diameter is usually measured with a transmission electron microscope.

The average plate diameter of the hexagonal ferrite powder can be adjusted, considering the concentration of a liquid when a precursor of the hexagonal ferrite powder is produced, the procedure of adding the liquid, the pH, and time for stirring the liquid; the temperature when additive elements are adhered to the precursor powder, and the pH, the concentration of the liquid, and thermal treatment conditions at the time; the kind and amount of the additive elements; and the calcining temperature of the precursor, the calcining time, the calcining atmosphere, the rate of temperature rise, and other conditions.

As the size of the hexagonal ferrite powder becomes smaller, the specific surface area generally becomes larger. The specific surface area of the hexagonal ferrite powder, based on the BET method, is preferably from 60 to 100 m²/g, more preferably from 65 to 100 m²/g, even more preferably from 70 to 100 m²/g. If the specific surface area of the hexagonal ferrite powder, based on the BET method, is more than 100 m²/g, the powder turns into the form that irregularities are present in the surface so that the dispersibility in the magnetic coating material lowers easily. If the specific surface area is less than 60 m²/g, the powder aggregates easily so that the dispersibility in the magnetic coating material lowers easily. The specific surface area of the hexagonal ferrite powder can be adjusted, considering the same conditions as in the method for adjusting the average plate diameter of the hexagonal ferrite powder.

The coercive force Hc of the hexagonal ferrite powder is preferably from 79.6 to 278.5 kA/m (1000 to 3500 Oe), and the saturation magnetization σs is preferably from 40 to 70 Am²/kg (emu/g). The Hc of the medium formed by use of the hexagonal ferrite powder is preferably from 94.8 to 318.3 kA/m (1200 to 4000 Oe).

As the binder resin in the upper magnetic layer, a resin containing a polar group is used in order to disperse the ferromagnetic powder satisfactorily. This polar-group-containing resin is not particularly limited, and may be any appropriate combination of resins selected from thermoplastic resin, thermosetting or reactive resin, radiation (electron beam or ultraviolet ray) curable resin, and others in accordance with property of the medium and conditions in the production process of the medium.

The thermoplastic resin may be a thermoplastic resin which has a softening temperature of 150° C. or lower, an average molecular weight of 5,000 to 200,000, and a polymerization degree of about 50 to 2,000. The thermosetting or reactive resin, or the radiation curable resin may be a resin which has an average molecular weight of 5,000 to 200,000 and a polymerization degree of about 50 to 2,000, and which is made large in molecular weight through condensation or addition reaction or some other reaction by undergoing applying, drying and calendering followed by heating and/or irradiation of radiation (electron beams or ultraviolet rays).

A preferred binder resin out of these resins is a combination of a polar-group-containing vinyl chloride copolymer as described below with a polar-group-containing polyurethane resin.

The vinyl chloride copolymer is preferably a copolymer having a vinyl chloride content by percentage of 60 to 95% by mass, in particular, 60 to 90% by mass, and an average polymerization degree of about 100 to 500.

Examples of the vinyl chloride resin include a vinyl chloride-vinyl acetate-vinyl alcohol copolymer, vinyl chloride-hydroxyalkyl (meth)acrylate copolymer, vinyl chloride-vinyl acetate-maleic acid copolymer, vinyl chloride-vinyl acetate-vinyl alcohol-maleic acid copolymer, vinyl chloride-vinyl acetate-hydroxyalkyl (meth)acrylate copolymer, vinyl chloride-vinyl acetate-hydroxyalkyl (meth)acrylate-maleic acid copolymer, vinyl chloride-vinyl acetate-vinyl alcohol-glycidyl (meth)acrylate copolymer, vinyl chloride-hydroxyalkyl (meth)acrylate-glycidyl (meth)acrylate copolymer, and vinyl chloride-hydroxyalkyl (meth)acrylate copolymer. Particularly preferred is a copolymer made from vinyl chloride and a monomer containing an epoxy(glycidyl) group.

The vinyl chloride copolymer is preferably a copolymer having, as the polar group, a sulfate group (—OSO₃Y) and/or a sulfo group (—SO₃Y) in order to improve the dispersibility wherein Y may be either H or an alkali metal (the two groups will be collectively referred to as a S-containing polar group hereinafter). In particular preferably, Y=K, that is, the S-containing polar group is —OSO₃K, or —SO₃K. The vinyl chloride copolymer may contain either one of the two groups as the S-containing polar group, or may contain the two. When the copolymer contains the two, the ratio between the contained amounts of the two may be selected at will. The S-containing polar group is preferably contained in a proportion of 40 to 100 eq/ton on the basis of mass of the vinyl chloride copolymer having the S-containing polar group.

The vinyl chloride copolymer may optionally contain, besides the S-containing polar group, a different polar group selected from —OPO₂Y, —PO₃Y, and —COOY groups wherein Y represents H or an alkali metal; and —NR₁R₂, and —N⁺R₁R₂R₃ groups wherein R₁, R₂ and R₃ each independently represent H, an alkyl group, or a hydroxyalkyl group. In this case, the different polar group is preferably contained in the following amount as a total amount of the different polar group and the S-containing polar group: an amount of 40 to 100 eq/ton on the basis of the mass of the vinyl chloride copolymer containing the polar group. When the vinyl chloride copolymer is synthesized, the ratio of the polar groups contained in the vinyl chloride copolymer can be appropriately changed by adjusting the ratio between the used amounts of starting monomer compounds containing the polar group.

The polyurethane resin, which is used together with the vinyl chloride resin, is a generic name of any resin that is obtained by reaction between hydroxy-group-containing resin(s), such as polyester polyol and/or polyether polyol, and a polyisocyanate-containing compound. The polyurethane resin has a number-average molecular weight of about 5,000 and 200,000 and a Q value (mass-average molecular weight/the number-average molecular weight) of about 1.5 to 4. The polyurethane resin is effective from the viewpoint of abrasion resistance and the adhesiveness of the lower non-magnetic layer.

The polyurethane resin is preferably a resin containing, at its terminal or side chains, at least one polar group selected from a S-containing polar group, a P-containing polar group, and a N-containing polar group, in particular preferably a S-containing polar group.

Examples of the polar group contained in the polyurethane resin include S-containing polar groups such as —SO₃M, —OSO₃M, and —SR, P-containing polar groups such as —PO₃M, —PO₂M, —POM, —P═O(OM₁)(OM₂) and —OP═O(OM₁)(OM₂), —COOM, —OH, —NR₁R₂, and —N⁺R₁R₂R₃X⁻ groups wherein M, M₁ and M₂ each represent H, Li, Na or K, R₁, R₂ and R₃ each independently represent H, or a hydrocarbon group, and X represents a halogen atom; epoxy groups; and —CN. It is preferred to use a polyurethane resin to which at least one polar group selected from these polar groups is introduced by copolymerization or addition reaction. The polar group may be present in the main chain of the skeleton resin or branches thereof. The polar group is preferably contained in a proportion of 40 to 300 eq/ton on the basis of the mass of polyurethane resin containing the polar group.

Such a polyurethane resin can be obtained by causing raw materials including a specific polar-group-containing compound and/or a raw resin caused to react with a specific polar-group-containing compound to react in a solvent or in no solvent by a known method. When the polyurethane resin is synthesized, the ratio of polar group contained in the polyurethane resin can be appropriately varied by adjusting the ratio between the amounts of used polar-group-containing compound.

The polyurethane resin is preferably a resin having the following glass transition temperature Tg: −20° C.≦Tg≦80° C.

It is preferred to mix the vinyl chloride resin and the polyurethane resin with each other to give a ratio by mass of the vinyl chloride resin to the polyurethane resin (the vinyl chloride resin/the polyurethane resin) in the range of 10/90 to 90/10, and use the resultant mixture.

In addition of the vinyl chloride resin and the polyurethane resin, a binder resin containing a polar group other than these resins, or a binder resin containing no polar group may be used. It is preferred to use the vinyl chloride resin and the polyurethane resin in an amount of 80% or more by mass of the total binder resin materials. In the case of using the binder resin containing no polar group, the amount thereof should be 20% or less by mass of the total binder resin materials. It is preferred not to use the binder resin containing no polar group.

The polar group of the binder resin is preferably contained in the proportion of 40 to 150 eq/ton on the basis of the mass of the total binder resin materials in the magnetic layer. The total of the binder resin materials includes the polar-group-containing binder resin(s), the binder resin containing no polar group, and a crosslinker (curing agent) described in the following.

Examples of crosslinkers used to harden the binder resin include various polyisocyanates, especially diisocyanates. Particularly, at least one selected from tolylene diisocyanate, hexamethylene diisocyanate, and methylene diisocyanate is particularly preferred. It is particularly preferred that these crosslinkers are modified with a compound containing a plurality of hydroxyl groups, such as trimethylolpropane, or that they are provided in the form of an isocyanulate-type crosslinker in which three molecules of a diisocyanate compound have been bound. In this manner, the crosslinkers can bind to functional groups present in the binder resins to thereby crosslink the resin. Preferably, the crosslinker is used in an amount of 10 to 30 parts by mass with respect to 100 parts by mass of the binder resin. In general, such thermosetting resins can be cured by heating them in an oven at 50 to 70° C. for 12 to 48 hours.

In the present invention, the polar-group-containing binder resin is contained in the magnetic layer to set the amount of the polar group per unit specific surface area of the ferromagnetic powder (based on the BET method) into the range of 0.18 to 0.35 μmol/m². In order to obtain a high reproducing output, it is advisable that the ferromagnetic powder is contained in the magnetic layer in an amount of about 70 to 90% by mass of the magnetic layer.

By using the polar-group-containing binder resin to set the number (concentration) of the polar groups in the above-mentioned specified range, the ferromagnetic powder having a large specific surface area and a fine size can be uniformly dispersed without lowering the ratio by weight of the ferromagnetic powder P to the binder resin B (the weight ratio P/B) in the magnetic layer coating material. Since the binder resin has a polar group and the polar group has affinity with the surface of the ferromagnetic powder, the ferromagnetic powder is dispersed. However, the amount of the binder resin that may be present near the fine-size ferromagnetic powder is limited. For this reason, even if the use amount of the binder resin is simply made large, a good dispersibility cannot be obtained so as to merely lower the weight ratio P/B. Since the fine-size ferromagnetic powder is large in specific surface area, it appears that an optimal number (concentration) of the polar groups which can contact the surface of the ferromagnetic powder exists. In the present invention, the number of the polar groups is set into an appropriate range in accordance with the unit specific surface area of the ferromagnetic powder, thereby dispersing the fine-size ferromagnetic powder uniformly without lowering the weight ratio P/B. As a result, the surface smoothness of the magnetic layer is improved by use of the fine-size ferromagnetic powder, so as to improve the output and decrease errors (that is, improve the electromagnetic conversion property).

If the amount of the polar-group-containing binder resin is such an amount that the amount of the polar group per unit specific surface area (based on the BET method) of the ferromagnetic powder is set to less than 0.18 μmol/m², the dispersibility of the ferromagnetic powder becomes insufficient. Specifically, the ferromagnetic powders are magnetically bounded to each other so as to form giant clusters. As a result, the magnetic layer surface is cracked. On the other hand, if the amount of the polar group is more than 0.35 μmol/m², the ferromagnetic powder is insufficiently dispersed. Specifically, the ferromagnetic powders are aggregated by interaction between the polar groups that are excessively present. As a result, the magnetic layer surface is cracked.

When the ratio by weight of the ferromagnetic powder P to the binder resin B (the weight ratio P/B) in the magnetic layer coating material becomes high, that is, when the binder resin B is used in a small amount, the amount of the binder resin B surrounding the ferromagnetic powder P becomes short even if the amount of the polar group is set into the desired range. Thus, the powder becomes poor in dispersibility. As a result, the powder falls so that the head is easily clogged with the powder. On the other hand, if the weight ratio P/B becomes low, that is, the binder resin B is used in a large amount, the filling ratio of the ferromagnetic powder P lowers even if the amount of the polar group is set into the desired range. As a result, an appropriate output is not easily obtained. The weight ratio P/B preferably ranges from 6/1 to 4.5/1, and it is preferred to use the polar-group-containing binder resin in such a manner that this range is satisfied and the amount of the polar group is set into the desired range. The crosslinker (curing agent) is usually added to the coating material after the ferromagnetic powder P and the binder resin(s) B are subjected to dispersing treatment; therefore, the weight ratio P/B is considered about the ferromagnetic powder P and the binder resin B without being involved in the crosslinker.

The upper magnetic layer further contains an abrasive having a Mohs hardness of 6 or more, such as α-alumina (Mohs hardness: 9), for the purposes of increasing the mechanical strength of the magnetic layer and preventing clogging of the magnetic head. Such an abrasive usually has an indeterminate form, causes the magnetic head to be prevented from clogging, and causes the strength of the coating film to be improved.

The average particle diameter of the abrasive is, for example, from 0.01 to 0.2 μm, preferably from 0.05 to 0.2 μm. If the average particle diameter of the abrasive is too large, then the projections from the surface of the magnetic layer become significant, causing a decrease in the electromagnetic conversion property, an increase in the drop-outs, an increase in the head wear, and the like. If the average particle diameter of the abrasive is too small, then the projections from the surface of the magnetic layer will become small, leading to insufficient prevention of clogged heads.

The average particle diameter is usually measured with a transmission electron microscope. The content of the abrasive may be from 3 to 25 parts by mass, preferably from 5 to 20 parts by mass with respect to 100 parts by mass of the ferromagnetic powder.

If necessary, various additives may be added to the magnetic layer, examples of the additives including dispersants such as a surfactant, and lubricants such as higher fatty acid, fatty acid ester, and silicone oil.

Further, a known dispersant is preferably incorporated into the upper magnetic layer in order to improve the dispersibility of the individual components.

A coating material for forming the upper magnetic layer is prepared by adding an organic solvent to the above-mentioned individual components, and subjecting the resultant to mixing, stirring, kneading, dispersing and/or some other treatment, by a known method. The organic solvent to be used is not particularly limited, and may be one or more selected appropriately from ketone solvents such as methyl ethyl ketone (MEK), methyl isobutyl ketone, and cyclohexanone, aromatic solvents such as toluene, and other solvents. It is advisable to set the addition amount of the organic solvent into the range of about 100 to 1900 parts by mass for 100 parts by mass of the total of the individual components.

The thickness of the upper magnetic layer is preferably 0.30 μm or less, from 0.03 to 0.30 μm, more preferably from 0.03 to 0.25 μm. If the magnetic layer is too thick, the self-demagnetization loss or thickness loss thereof increases.

The centerline average roughness (Ra) of the upper magnetic layer surface is preferably from 1.0 to 5.0 nm, more preferably from 1.0 to 4.0 nm. If the Ra is less than 1.0 nm, the surface is too smooth so that the running stability deteriorates. As a result, troubles are easily caused during running of the recording medium. On the other hand, if the Ra is more than 5.0 nm, the magnetic layer surface gets rough. As a result, the electromagnetic conversion properties of the magnetic recording medium, such as the reproducing output thereof, deteriorate in a reproducing system using an MR head.

### [Lower Non-Magnetic Layer]

The lower non-magnetic layer comprises at least carbon black, a non-magnetic inorganic powder other than carbon black, and a binder resin material.

The carbon black contained in the lower non-magnetic layer may be furnace black for rubber, thermal black for rubber, black for color, acetylene black or the like. It is preferred that the specific area thereof is from 5 to 600 m²/g, the DBP oil absorption thereof is from 30 to 400 mL/100 g, and the particle diameter thereof is from 10 to 100 nm. For the carbon black which can be used, specifically, “carbon black guide book” edited by the Carbon Black Association of Japan can be referred to.

The amount of the carbon black incorporated into the lower non-magnetic layer is from 5 to 30% by mass, preferably from 10 to 25% by mass of the lower non-magnetic layer.

The non-magnetic inorganic powder other than carbon black, which is contained in the lower non-magnetic layer, is an inorganic powder made of, for example, α-iron oxide (α-Fe₂O₃) α-iron hydroxide (α-FeO(OH)), CaCO₃, titanium oxide, barium sulfate, or α-Al₂O₃. It is preferred that at least one of α-iron oxide and α-iron hydroxide out of these materials is contained in the layer. It is also preferred that α-iron oxide and α-iron hydroxide are each acicular.

The blend ratio by mass of carbon black to the non-magnetic inorganic powder other than carbon black (carbon black/the non-magnetic inorganic powder other than carbon black (mass ratio)) is preferably from 95/5 to 5/95. If the percentage of blended carbon black is less than 5% by mass, a problem about surface electrical resistance may be caused. If the percentage of the blended non-magnetic inorganic powder other than carbon black is less than 5% by mass, the surface smoothness of the lower non-magnetic layer may deteriorate and the mechanical strength thereof may lower. The deterioration in the surface smoothness of the lower non-magnetic layer causes a deterioration in the surface smoothness of the upper magnetic layer.

The binder resin of the lower non-magnetic layer may be a combination that is appropriately selected from thermoplastic resins, thermosetting or thermoreactive resins, radiation (electron beam or ultraviolet ray) curable resins and other resins in accordance with the property of the medium or conditions for the production process thereof. Of these resins, electron beam curable resins are preferred. More preferred is a combination of electron beam curable vinyl chloride copolymer and polyurethane resin described below.

The vinyl chloride copolymer is preferably one having a vinyl chloride content of 50 to 95% by mass, and is more preferably one having a vinyl chloride content of 55 to 90% by mass. The average degree of polymerization thereof is preferably from about 100 to 500. Particularly, preferable is a copolymer made from vinyl chloride and a monomer having an epoxy (glycidyl) group. The vinyl chloride copolymer is modified to be electron beam sensitive by introducing (meth)acrylic double bonds, or the like, using known techniques.

The polyurethane resin, which is used together with the vinyl chloride resin, is a generic name given to resins obtained by reaction of hydroxy group containing resins, such as polyester polyol and/or polyether polyol, with polyisocyanate-containing compounds. The number-average molecular weight thereof is from about 5,000 to 200,000, and the Q value (i.e., the mass-average molecular weight/the number-average molecular weight) thereof is from about 1.5 to 4. The polyurethane resin is modified to be electron beam sensitive by introducing (meth)acrylic double bonds using known techniques.

Besides the vinyl chloride copolymer and the polyurethane resin, known various resins may be incorporated into the non-magnetic layer at an amount in the range of 20% or less by mass of all the binders in this layer.

The content of the binder resin used in the lower non-magnetic layer is preferably from 10 to 100 parts by mass, more preferably from 12 to 30 parts by mass with respect to 100 parts by mass of the total of the carbon black and the non-magnetic inorganic powder other than the carbon black in the lower non-magnetic layer. If the content of the binder is too small, the ratio of the binder resin in the lower non-magnetic layer lowers so that a sufficient coating film strength cannot be obtained. If the content of the binder is too large, the medium, when being made into a tape, is easily warped along the width direction of the tape. Consequently, the state of contact between the tape and a head tends to get bad.

It is preferred that the lower non-magnetic layer comprises a lubricant if necessary. The lubricant may be saturated or unsaturated, and may be a known lubricant, examples of which include fatty acids such as stearic acid and myristic acid; fatty acid esters such as butyl stearate and butyl palmitate; and sugars. These may be used alone or in a mixture of two or more thereof. It is preferred to use a mixture of two or more fatty acids having different melting points, or a mixture of two or more fatty acid esters having different melting points. This is because it is necessary to supply lubricants adapted to all temperature environments in which the magnetic recording medium is used onto the surface of the medium without interruption.

The lubricant content in the lower non-magnetic layer may be appropriately adjusted in accordance with purpose, and is preferably from 1 to 20% by mass of the total mass of the carbon black and the non-magnetic inorganic powder other than the carbon black in the lower non-magnetic layer.

A coating material for forming the lower non-magnetic layer is prepared by adding an organic solvent to the above-mentioned individual components and subjecting the resultant to mixing, stirring, kneading, dispersing and other treatments in a known manner. The used organic solvent is not limited to any especial kind, and may be the same as used in the upper magnetic layer. The amount of the added organic solvent is set into the range of about 100 to 900 parts by mass with respect to 100 parts by mass of the total of the carbon black, the various inorganic powder(s) other than the carbon black, the binder resin, and polyfunctional monomer.

The thickness of the lower non-magnetic layer is usually from 0.3 to 2.5 μm, preferably from 0.5 to 2.0 μm. If the non-magnetic layer is too thin, the layer is easily affected by the surface roughness of the non-magnetic support so that the surface smoothness of the non-magnetic layer deteriorates and, also, the surface smoothness of the magnetic layer deteriorates easily. Consequently, the electromagnetic conversion property of the magnetic layer tends to deteriorate. Also, too thin a non-magnetic layer leads to an increased light transmittance, causing problems when medium end is detected by the changes in the light transmittance. On the other hand, making a non-magnetic layer thicker than a certain thickness would not correspondingly improve the performance of the magnetic recording medium.

### [Back Coat Layer]

A back coat layer is optionally provided in order to improve the running stability, and prevent the electrification of the magnetic layer or others. The structure and the composition thereof are not particularly limited. It is allowable to use, for example, a back coat layer containing carbon black, a non-magnetic inorganic powder other than carbon black, and a binder resin.

The back coat layer preferably contains carbon black in an amount of 30 to 80% by weight of the back coat layer as a standard.

The back coat layer may contain various non-magnetic inorganic powders other than the carbon black in order to control the mechanical strength. Examples of the inorganic powders include α-Fe₂O₃, CaCO₃, titaniumoxide, barium sulfate, α-Al₂O₃, and the like.

A coating material for forming a back coat layer is prepared by adding an organic solvent to the individual components, and subjecting the resultant to mixing, stirring, kneading, dispersing and/or some other treatment(s) in known manners. The used organic solvent is not particularly limited, and may be the same as used in the upper magnetic layer coating material or the lower non-magnetic layer coating material.

The thickness of the back coat layer (after the layer is calendered) is 1.0 μm or less, preferably from 0.1 to 1.0 μm, more preferably from 0.2 to 0.8 μm.

### [Non-Magnetic Support]

The material used for the non-magnetic support is not particularly limited, and may be selected from various flexible materials, and various rigid materials in accordance with the purpose. The support should be made into a predetermined shape, such as a tape shape, sheet shape, card shape, and disk shape, and a predetermined size, in accordance with one out of various standards. Examples of the flexible materials include polyesters such as polyethylene terephthalate (PET) and polyethylene naphthalate (PEN), polyolefins such as polypropylene, and various resins such as polyamide (PA), polyimide (PI), polyamideimide (PAI), and polycarbonate. The non-magnetic support is preferably a film made of a resin selected from PEN, PA, PI, and PAI. The thickness of the non-magnetic support is, for example, 3.0 to 15.0 μm, and preferably from 2.0 to 6.0 μm.

### [Production of Magnetic Recording Medium]

In the present invention, prepared coating materials for forming the non-magnetic layer, for forming the magnetic layer, and for forming the back coat layer are used and subjected to applying, drying, calendering, curing and other treatments so as to form respective coating films (coating layers). In this way, a magnetic recording medium is produced.

In the present invention, it is preferred that the lower non-magnetic layer and the upper magnetic layer are formed in the so-called wet-on-dry coating manner. However, the layers may be formed in the wet-on-wet coating manner. In the case of the wet-on-dry coating manner, a coating material for the non-magnetic layer is first applied onto one surface of a non-magnetic support, and dried, and optionally the resultant is subjected to calendaring treatment, so as to yield an uncured lower non-magnetic layer. Thereafter, the uncured lower non-magnetic layer is cured. In the case of using an electron beam curable resin as the binder resin material of the lower non-magnetic layer, the lower non-magnetic layer is irradiated with an electron beam, so as to be cured. Next, a coating material for the magnetic layer is applied onto the cured lower non-magnetic layer, oriented and dried to form the upper magnetic layer. The timing when the back coat layer is formed may be selected at will. Specifically, the back coat layer may be formed before the formation of the lower non-magnetic layer, after the formation of the lower non-magnetic layer and before that of the upper magnetic layer, or after the formation of the upper magnetic layer.

The method used for applying the above-mentioned coating materials may be any one selected from known various coating methods such as gravure coating, reverse roll coating, die nozzle coating, and bar coating.

### EXAMPLES

The present invention will be more specifically described by way of the following examples; however, the present invention is not limited to the examples.

### [Method for Measuring Powder Property]

### (Measurement of the Average Major Axis Length, and the Average Plate Diameter)

A powder to be measured was photographed with a transmission electron microscope (TEM) with a magnification of 100,000. About 100 particle-images drawn at random from the photograph, the major axis lengths and the plate diameters were measured. The average of these values was defined as the average major axis length and the average plate diameter, respectively.

### (Measurement of the Specific Surface Area)

A BET measuring device (one out of NOVA 2000 series, manufactured by Quantachrome Co.) was used to measure the specific surface area by the BET method. The BET measurement is, for example, a measurement of deaerating a powder sample, and causing the sample to adsorb molecules having a known adsorption occupation area, and then calculating the specific surface area of the sample from the amount of the elimination of the molecules subsequently.

### Example 1

### Preparation of a Non-Magnetic Layer Coating Material

Non-magnetic powder, Acicular α-FeOOH 80.0 parts by mass (average major axis length: 0.1 μm, crystallite size: 12 nm) Non-magnetic powder, Carbon black 20.0 parts by mass (trade name: #950B, manufactured by Mitsubishi Chemical Co., Ltd., average particle diameter: 17 nm, BET specific surface area: 250 m²/g, DBP oil absorption: 70 mL/100 g, pH: 8) Electron beam curable binder, Electron beam curable vinyl chloride resin 12.0 parts by mass (trade name: TB-0246, manufactured by Toyobo Co., Ltd., (solid content) vinyl chloride—epoxy containing monomer copolymer, average degree of polymerization: 310, content of S based on the use of potassium persulfate: 0.6% by mass, MR110 (manufactured by Nippon Zeon Corp.) subjected to acrylic modification with 2-isocyanate ethyl methacrylate (MOI), acryl content: 6 mol/1 mol)
Electron beam curable binder, Electron beam curable polyurethane resin 10.0 parts by mass (trade name: TB-0216, manufactured by Toyobo Co., Ltd., (solid content) hydroxy-containing acrylic compound—phosphonic acid group-containing phosphorus compound—hydroxy-containing polyester polyol, average molecular weight: 13,000, P content: 0.2% by mass, acryl content: 8 mol/1 mol)
Dispersant, phosphoric acid ester surfactant 3.2 part by mass (trade name: RE-610, manufactured by TOHO Chemical Industry Co., Ltd.)
Abrasive, α-alumina 5.0 parts by mass (trade name: HIT60A, manufactured by Sumitomo Chemical Co., Ltd., average particle diameter: 0.18 μm)
NV (solid concentration)=33% by mass
Solvent ratio: MEK/toluene/cyclohexane=2/2/1 (ratio by mass)

The above-mentioned materials were subjected to kneading treatment with a kneader. Thereafter, the mixture was dispersed in a lateral type pin mill, filled with zirconia beads of 0.8 mm diameter at a filling ratio of 80% (percentage of voids: 50% by volume). Thereafter, to this dispersion were further added the following lubricant materials:

0.5 part by mass of lubricant; fatty acid

(trade name: NAA180, manufactured by NFO Corp.),

0.5 part by mass of lubricant; fatty acid amide

(trade name: Fatty Acid AMIDE S, manufactured by Kao Corp.), and

1.0 parts by mass of lubricant; fatty acid ester

(trade name: NIKKOLBS, manufactured by Nikko Chemicals Co., Ltd.),

and the dispersion was diluted to have a NV (solid concentration) of 25% by mass and the following solvent ratio by mass: MEK/toluene/cyclohexane=2/2/1. Thereafter, the mixture was dispersed. Subsequently, the resultant coating material was filtrated through a filter having an absolute filtration precision of 1.0 μm to prepare a non-magnetic coating material.

### (Preparation of a Magnetic Layer Coating Material)

Ferromagnetic powder: Fe acicular ferromagnetic powder 100.0 parts by mass (Fe/Co/Al/Y=100/24/29/14 (ratio by atom), Hc: 215 kA/m, σs: 130 μm²/kg, BET specific surface area: 70 m²/g, average major axis length: 35 nm)
Thermosetting vinyl chloride resin: vinyl chloride copolymer 12.0 parts by mass (trade name: MR110, manufactured by Nippon Zeon Co., Ltd., polar group concentration: 63 eq/ton)
Thermosetting polyurethane resin: polyester polyurethane 8.0 parts by mass (containing sodium sulfonate polar groups, polar group concentration: 41 eq/ton)
Dispersant: phosphoric acid surfactant 1.5 parts by mass (trade name: RE610, manufactured by Toho Chemical Industry Co., Ltd.)
Abrasive: α-alumina 10.0 parts by mass (trade name: HIT60A, manufactured by Sumitomo Chemical Co., Ltd., average particle diameter: 0.18 μm)
NV (solid concentration)=30% by mass
Solvent ratio: MEK/toluene/cyclohexanone=4/4/2 (ratio by mass)

The above-mentioned materials were kneaded by a kneader. Thereafter, for pre-dispersion of the solid components, the materials were dispersed by a lateral type pin mill into which zirconia beads having a diameter of 0.8 mm were filled at a filling ratio of 80% (percentage of voids: 50% by volume). Next, the resultant was diluted to give an NV (solid concentration) of 10% by mass and a solvent ratio (MEK/toluene/cyclohexane) of 15/15/70 (ratio by mass). The resultant was then finish-dispersed.

Subsequently, to the resultant coating material was added a heat-hardener (trade name: COLONATE L, manufactured by Nippon Polyurethane Industry Co., Ltd.) to set the amount of any solid in the heat-hardener to 20% by mass of the total parts by mass of the above binder resins. The components were mixed. Thereafter, the mixture was filtrated through a filter having an absolute filtration precision of 0.5 μm to produce a magnetic layer coating material of Example 1.

### (Preparation of a Back Coat Layer Coating Material)

Carbon black 75.0 parts by mass (trade name: BP-800, manufactured by Cabot Corp., average particle diameter: 17 nm, DBP oil absorption: 68 mL/100 g, BET specific surface area: 210 m²/g)
Carbon black 15.0 parts by mass (trade name: BP-130, manufactured by Cabot Corp., average particle diameter: 75 nm, DBP oil absorption: 69 mL/100 g, BET specific surface area: 25 m²/g)
Calcium carbonate 10.0 parts by mass (trade name: HAKUENKA 0, manufactured by Shiraishi Kogyo, average particle diameter: 30 nm)
Nitrocellulose 65.0 parts by mass (trade name: BTH1/2, manufactured by Asahi Chemical Co., Ltd.)
Polyurethane resin 35.0 parts by mass (aliphatic polyester diol/aromatic polyester diol=43/57) NV (solid concentration)=30% by mass
Solvent ratio: MEK/toluene/cyclohexane=1/1/1 (ratio by mass)

The above-mentioned materials from which some of the organic solvents were removed, which were in a high viscosity state, were sufficiently kneaded by a kneader. Next, the removed organic solvents were added to the kneaded materials, and the resultant was sufficiently stirred by a dissolver. The materials were then kneaded by a kneader. Thereafter, for pre-dispersion of the solid components in the kneaded product, the components were dispersed by a lateral type pin mill into which zirconia beads having a diameter of 0.8 mm were filled at a filling ratio of 80% (percentage of voids: 50% by volume).

Thereafter, the pre-dispersed material was further diluted to give an NV (solid concentration) of 10% (percentage by mass) and a solvent ratio (MEK/toluene/cyclohexane) of 50.0/40.0/10.0 (ratio by mass). The resultant was then finish-dispersed. Subsequently, to the resultant coating material were added 10 parts by mass of a heat-hardener (trade name: COLONATE L, manufactured by Nippon Polyurethane Industry Co., Ltd.), and the components were mixed. Thereafter, the mixture was further filtrated through a filter having an absolute filtration precision of 0.5 μm to produce a back coat layer coating material.

### (Step of Forming a Non-Magnetic Layer)

The non-magnetic layer coating material was applied onto one surface of a base film (polyethylene naphthalate film) 6.2 μm in thickness by extrusion coating method from a nozzle, so as to give a thickness of 2.0 μm after calendering described below. The applied layer was dried. Thereafter, a calender in which a plastic roll was combined with a metal roll was used to calender the resultant under the following conditions: the nip number: 4, working temperature: 100° C., and linear pressure: 3500 N/cm. Furthermore, electron beams were radiated thereto at an irradiation dose of 4.0 Mrad and an accelerating voltage of 200 kV to form a lower non-magnetic layer.

### (Step of Forming a Magnetic Layer)

The magnetic layer coating material was applied onto the lower non-magnetic layer formed as described above by extrusion coating method from a nozzle, so as to give a thickness of 0.2 μm after calendering described below. The resultant was oriented and dried. Thereafter, a calender in which a plastic roll was combined with a metal roll was used to calender the resultant under the following conditions: the nip number: 4, working temperature: 100° C., and linear pressure: 3500 N/cm. In this way, an upper magnetic layer was formed.

### (Step of Forming a Back Coat Layer)

The back coat layer coating material was applied onto the other surface of the base film by extrusion coating method from a nozzle, so as to give a thickness of 0.7 μm after calendering described below. The resultant was then dried. Thereafter, a calender in which a plastic roll was combined with a metal roll was used to calender the resultant under the following conditions: the nip number: 4, working temperature: 100° C., and linear pressure: 3500 N/cm. In this way, a back coat layer was formed.

The magnetic recording tape web yielded as described above was thermally set at 60° C. for 48 hours. Next, the tape web was slit into a width of ½ inch (=12.650 mm) to form a tape for data as a magnetic recording tape sample of Example 1.

### Examples 2 to 12, and Comparative Examples 1 to 8

Magnetic layer coating materials were each prepared in the same way as in Example 1 except that:

each of Fe acicular ferromagnetic powders having average major axis lengths and BET specific surface areas shown in Table 1 was used as a ferromagnetic powder in an amount of 100 parts by mass,

a vinyl chloride copolymer (trade name: MR110 or MR104, manufactured by Nippon Zeon Co., Ltd., polar group concentration: 94 eq/ton) shown in Table 1 was used as a thermosetting vinyl chloride resin in an amount of 12.0 parts by mass, and each of polyester polyurethanes containing sodium sulfonate polar groups wherein the concentrations of the polar groups were shown in Table 1 was used as a thermosetting polyurethane resin in an amount of 8.0 parts by mass. The resultant magnetic layer coating materials were each used to form each magnetic recording tape sample in the same way as in Example 1.

### Examples 13 and 14

Magnetic layer coating materials were each prepared in the same way as in Example 1 except that:

each of Fe acicular ferromagnetic powders having average major axis lengths and BET specific surface areas shown in Table 1 was used as a ferromagnetic powder in an amount of 100.0 parts by mass,

a vinyl chloride copolymer (trade name: MR110 or MR104) shown in Table 1 was used as a thermosetting vinyl chloride resin in an amount of 10 parts by mass, and each of polyester polyurethanes containing sodium sulfonate polar groups wherein the concentrations of the polar groups were shown in Table 1 was used as a thermosetting polyurethane resin in an amount of 6.7 parts by mass. The resultant magnetic layer coating materials were each used to form each magnetic recording tape sample in the same way as in Example 1.

### Examples 15 and 16

Magnetic layer coating materials were each prepared in the same way as in Example 1 except that:

each of Fe acicular ferromagnetic powders having average major axis lengths and BET specific surface areas shown in Table 1 was used as a ferromagnetic powder in an amount of 100.0 parts by mass,

a vinyl chloride copolymer (trade name: MR110 or MR104) shown in Table 1 was used as a thermosetting vinyl chloride resin in an amount of 13.3 parts by mass, and

each of polyester polyurethanes containing sodium sulfonate polar groups wherein the concentrations of the polar groups were shown in Table 1 was used as a thermosetting polyurethane resin in an amount of 8.9 parts by mass. The resultant magnetic layer coating materials were each used to form each magnetic recording tape sample in the same way as in Example 1.

### [Evaluation of the Magnetic Tapes]

About each of the magnetic recording tape samples, the following evaluations were made:

### (Observation of the Tape Surfaces)

A differential interference microscope was used to observe the magnetic layer surface of each of the tapes with magnification of 100 and 200. When surface cracking and aggregation were not recognized in the observed surface, the tape is designated as “A” in Table 1. When any one or both of surface cracking and aggregation were recognized, the tape is designated as “B” in Table 1.

### (Surface Roughness (Centerline Average Roughness: Ra))

A system (trade name: TALYSTEP SYSTEM, manufactured by Taylor Hobson Co.) was used to measure the centerline average roughness Ra of the magnetic layer surface of the tape in accordance with JIS B0601-1982.

Conditions for the measurement were as follows: filter wavelength: 0.18 to 9 Hz, probe: 0.1×2.5 μm stylus, probe pressure: 2 mg, measuring velocity: 0.03 mm/sec., and measurement length: 500 μm. The measurement of the roughness Ra of the magnetic layer surface was made after the final calendering treatment and curing treatment.

(Measurement of the Bit Error Rate (bER))

About each of the magnetic tape samples set into a cartridge, signals were recorded by mean of a magnetic recording head using a single recording wavelength of 0.25 μm as a recording wavelength Signals having a P-P value (amplitude) of 50% or less of the P-P value (amplitude) of the above-mentioned signals were defined as missing pulses. Four or more continuous missing pulses were detected as a long defect. The number of long defects per meter of the magnetic tape sample of Comparative Example 1, as a reference tape, was represented by N, and the number of long defects per meter of each of the magnetic tape samples was represented by X. About each of the magnetic tape samples, the log₁₀(X/N) was calculated as the bit error rate thereof. The calculated individual bit error rates were compared. The used reproducing head was a magneto resistive magnetic head (MR head).

The results from the above-mentioned measurements are shown in Table 1.

TABLE 1

| | Ferromagnetic | | | | | | | | | |
|---|---|---|---|---|---|---|---|---|---|---|
| | Fe | | | | | | | | | |
| | powder | | Vinyl | | | | | | | |
| | Average | | chloride | | | | | | | |
| | major | Specific | resin | | Polyurethane | Concentration | | Magnetic tape | | |
| | axis | surface | | Polar | resin | of | | Observation | Surface | |
| | length | area | | group | Polar group | polar group | | with | roughness | |
| | [nm] | [m²/g] | Kind | [eq/t] | [eq/t] | [μmol/m²] | P/B | microscope | Ra [nm] | bER |
| Example 1 | 35 | 60 | MR110 | 63 | 41 | 0.18 | 5/1 | A | 2.0 | −2.00 |
| Example 2 | 35 | 65 | MR110 | 63 | 52 | 0.18 | 5/1 | A | 2.0 | −2.00 |
| Example 3 | 35 | 70 | MR110 | 63 | 63 | 0.18 | 5/1 | A | 2.0 | −2.00 |
| Example 4 | 35 | 100 | MR104 | 94 | 296 | 0.35 | 5/1 | A | 1.9 | −2.10 |
| Example 5 | 10 | 60 | MR110 | 63 | 41 | 0.18 | 5/1 | A | 2.2 | −1.80 |
| Example 6 | 10 | 65 | MR110 | 63 | 52 | 0.18 | 5/1 | A | 2.2 | −1.80 |
| Example 7 | 10 | 70 | MR110 | 63 | 63 | 0.18 | 5/1 | A | 2.2 | −1.80 |
| Example 8 | 10 | 100 | MR104 | 94 | 296 | 0.35 | 5/1 | A | 2.1 | −1.90 |
| Example 9 | 50 | 60 | MR110 | 63 | 41 | 0.18 | 5/1 | A | 2.5 | −1.50 |
| Example 10 | 50 | 65 | MR110 | 63 | 52 | 0.18 | 5/1 | A | 2.5 | −1.50 |
| Example 11 | 50 | 70 | MR110 | 63 | 63 | 0.18 | 5/1 | A | 2.5 | −1.50 |
| Example 12 | 50 | 100 | MR104 | 94 | 296 | 0.35 | 5/1 | A | 2.4 | −1.60 |
| Example 13 | 35 | 60 | MR110 | 63 | 68 | 0.18 | 6/1 | A | 1.6 | −2.40 |
| Example 14 | 35 | 100 | MR104 | 94 | 382 | 0.35 | 6/1 | A | 1.5 | −2.50 |
| Example 15 | 35 | 60 | MR110 | 63 | 28 | 0.18 | 4.5/1 | A | 2.6 | −1.40 |
| Example 16 | 35 | 100 | MR104 | 94 | 252 | 0.35 | 4.5/1 | A | 2.5 | −1.50 |
| Comparative | 5 | 60 | MR110 | 63 | 41 | 0.18 | 5/1 | A | 4.0 | ±0.00 |
| Example 1 | | | | | | | | | | |
| Comparative | 5 | 100 | MR104 | 94 | 296 | 0.35 | 5/1 | A | 3.9 | −0.10 |
| Example 2 | | | | | | | | | | |
| Comparative | 55 | 60 | MR110 | 63 | 41 | 0.18 | 5/1 | A | 4.5 | +0.50 |
| Example 3 | | | | | | | | | | |
| Comparative | 55 | 100 | MR104 | 94 | 296 | 0.35 | 5/1 | A | 4.4 | +0.40 |
| Example 4 | | | | | | | | | | |
| Comparative | 10 | 60 | MR110 | 63 | 18 | 0.15 | 5/1 | B | 5.0 | +1.00 |
| Example 5 | | | | | | | | | | |
| Comparative | 10 | 100 | MR110 | 63 | 93 | 0.15 | 5/1 | B | 5.1 | +1.10 |
| Example 6 | | | | | | | | | | |
| Comparative | 50 | 60 | MR104 | 94 | 159 | 0.40 | 5/1 | B | 5.5 | +1.50 |
| Example 7 | | | | | | | | | | |
| Comparative | 50 | 100 | MR104 | 94 | 359 | 0.40 | 5/1 | B | 5.4 | +1.40 |
| Example 8 | | | | | | | | | | |

### Example 17

### Preparation of a Magnetic Layer Coating Material

Ferromagnetic powder: hexagonal ferrite powder 100.0 parts by mass (Hc: 215 kA/m, σs: 50 Am²/kg, BET specific surface area: 70 m²/g, average plate diameter: 20 nm)
Thermosetting vinyl chloride resin: vinyl chloride copolymer 12.0 parts by mass (trade name: MR110, manufactured by Nippon Zeon Co., Ltd., polar group concentration: 63 eq/ton)
Thermosetting polyurethane resin: polyester polyurethane 8.0 parts by mass (containing sodium sulfonate polar groups, polar group concentration: 41 eq/ton)
Dispersant: phosphoric acid surfactant 1.5 parts by mass (trade name: RE610, manufactured by Toho Chemical Industry Co., Ltd.)
Abrasive: α-alumina 10.0 parts by mass (tradename: HIT60A, manufactured by Sumitomo Chemical Co., Ltd., average particle diameter: 0.18 μm)
NV (solid concentration)=30% by mass
Solvent ratio: MEK/toluene/cyclohexanone=4/4/2 (ratio by mass)

The above-mentioned materials were kneaded by a kneader. Thereafter, for pre-dispersion of the solid components, the materials were dispersed by a lateral type mill into which zirconia beads having a diameter of 0.8 mm were filled at a filling ratio of 80% (percentage of voids: 50% by volume). Next, the resultant was diluted to give an NV (solid concentration) of 10% by mass and a solvent ratio (MEK/toluene/cyclohexane) of 15/15/70 (ratio by mass). The resultant was then finish-dispersed.

Subsequently, to the resultant coating material was added a heat-hardener (trade name: COLONATE L, manufactured by Nippon Polyurethane Industry Co., Ltd.) to set the amount of any solid in the heat-hardener to 20% by mass of the total parts by mass of the above binder resins. The components were mixed. Thereafter, the mixture was filtrated through a filter having an absolute filtration precision of 0.5 μm to produce a magnetic layer coating material of Example 17.

The resultant magnetic layer coating material, and the same non-magnetic layer coating material and back coat layer coating material as used in Example 1 were used to form a magnetic recording tape sample of Example 17 in the same way as in Example 1.

### Examples 18 to 28, and Comparative Examples 9 to 16

Magnetic layer coating materials were each prepared in the same way as in Example 17 except that:

each of hexagonal ferrite powders having average plate diameter and BET specific surface areas shown in Table 2 was used as a ferromagnetic powder in an amount of 100.0 parts by mass,

a vinyl chloride copolymer (trade name: MR110 or MR104) shown in Table 2 was used as a thermosetting vinyl chloride resin in an amount of 12.0 parts by mass, and

each of polyester polyurethanes containing sodium sulfonate polar groups wherein the concentrations of the polar groups were shown in Table 2 was used as a thermosetting polyurethane resin in an amount of 8.0 parts by mass. The resultant magnetic layer coating materials were each used to form each magnetic recording tape sample in the same way as in Example 17.

### Examples 29 and 30

Magnetic layer coating materials were each prepared in the same way as in Example 17 except that:

each of hexagonal ferrite powders having average plate diameter and BET specific surface areas shown in Table 2 was used as a ferromagnetic powder in an amount of 100.0 parts by mass,

a vinyl chloride copolymer (trade name: MR110 or MR104) shown in Table 2 was used as a thermosetting vinyl chloride resin in an amount of 10 parts by mass, and

each of polyester polyurethanes containing sodium sulfonate polar groups wherein the concentrations of the polar groups were shown in Table 2 was used as a thermosetting polyurethane resin in an amount of 6.7 parts by mass. The resultant magnetic layer coating materials were each used to form each magnetic recording tape sample in the same way as in Example 17.

### Examples 31 and 32

Magnetic layer coating materials were each prepared in the same way as in Example 17 except that:

each of hexagonal ferrite powders having average plate diameter and BET specific surface areas shown in Table 2 was used as a ferromagnetic powder in an amount of 100.0 parts by mass,

a vinyl chloride copolymer (trade name: MR110 or MR104) shown in Table 2 was used as a thermosetting vinyl chloride resin in an amount of 13.3 parts by mass, and

each of polyester polyurethanes containing sodium sulfonate polar groups wherein the concentrations of the polar groups were shown in Table 2 was used as a thermosetting polyurethane resin in an amount of 8.9 parts by mass. The resultant magnetic layer coating materials were each used to form each magnetic recording tape sample in the same way as in Example 17.

### [Evaluations of the Magnetic Tapes]

About each of the magnetic recording tape samples, evaluations were made in the same way as described above.

The results from the above-mentioned evaluations are shown in Table 2.

TABLE 2

| | Hexagonal | | | | | | | | | |
|---|---|---|---|---|---|---|---|---|---|---|
| | ferrite | | Vinyl | | | | | | | |
| | powder | | chloride | | | | | | | |
| | Average | Specific | resin | | Polyurethane | Concentration | | Magnetic tape | | |
| | plate | surface | | Polar | resin | of | | Observation | Surface | |
| | diameter | area | | group | Polar group | polar group | | with | roughness | |
| | [nm] | [m²/g] | Kind | [eq/t] | [eq/t] | [μmol/m²] | P/B | microscope | Ra [nm] | bER |
| Example 17 | 20 | 60 | MR110 | 63 | 41 | 0.18 | 5/1 | A | 2.3 | −1.70 |
| Example 18 | 20 | 65 | MR110 | 63 | 52 | 0.18 | 5/1 | A | 2.3 | −1.80 |
| Example 19 | 20 | 70 | MR110 | 63 | 63 | 0.18 | 5/1 | A | 2.3 | −1.80 |
| Example 20 | 20 | 100 | MR104 | 94 | 296 | 0.35 | 5/1 | A | 2.2 | −1.80 |
| Example 21 | 40 | 60 | MR110 | 63 | 41 | 0.18 | 5/1 | A | 2.5 | −1.70 |
| Example 22 | 40 | 65 | MR110 | 63 | 52 | 0.18 | 5/1 | A | 2.5 | −1.70 |
| Example 23 | 40 | 70 | MR110 | 63 | 63 | 0.18 | 5/1 | A | 2.5 | −1.70 |
| Example 24 | 40 | 100 | MR104 | 94 | 296 | 0.35 | 5/1 | A | 2.4 | −1.80 |
| Example 25 | 5 | 60 | MR110 | 63 | 41 | 0.18 | 5/1 | A | 2.5 | −1.50 |
| Example 26 | 5 | 65 | MR110 | 63 | 52 | 0.18 | 5/1 | A | 2.5 | −1.50 |
| Example 27 | 5 | 70 | MR110 | 63 | 63 | 0.18 | 5/1 | A | 2.5 | −1.50 |
| Example 28 | 5 | 100 | MR104 | 94 | 296 | 0.35 | 5/1 | A | 2.4 | −1.60 |
| Example 29 | 20 | 60 | MR110 | 63 | 68 | 0.18 | 6/1 | A | 1.9 | −2.10 |
| Example 30 | 20 | 100 | MR104 | 94 | 382 | 0.35 | 6/1 | A | 1.8 | −2.20 |
| Example 31 | 20 | 60 | MR110 | 63 | 28 | 0.18 | 4.5/1 | A | 2.9 | −1.10 |
| Example 32 | 20 | 100 | MR104 | 94 | 252 | 0.35 | 4.5/1 | A | 2.8 | −1.20 |
| Comparative | 3 | 60 | MR110 | 63 | 41 | 0.18 | 5/1 | A | 4.3 | +0.30 |
| Example 9 | | | | | | | | | | |
| Comparative | 3 | 100 | MR104 | 94 | 296 | 0.35 | 5/1 | A | 4.2 | +0.20 |
| Example 10 | | | | | | | | | | |
| Comparative | 50 | 60 | MR110 | 63 | 41 | 0.18 | 5/1 | A | 4.8 | +0.80 |
| Example 11 | | | | | | | | | | |
| Comparative | 50 | 100 | MR104 | 94 | 296 | 0.35 | 5/1 | A | 4.7 | +0.70 |
| Example 12 | | | | | | | | | | |
| Comparative | 5 | 60 | MR110 | 63 | 18 | 0.15 | 5/1 | B | 5.3 | +1.30 |
| Example 13 | | | | | | | | | | |
| Comparative | 5 | 100 | MR110 | 63 | 93 | 0.15 | 5/1 | B | 5.4 | +1.40 |
| Example 14 | | | | | | | | | | |
| Comparative | 40 | 60 | MR104 | 94 | 159 | 0.40 | 5/1 | B | 5.8 | +1.80 |
| Example 15 | | | | | | | | | | |
| Comparative | 40 | 100 | MR104 | 94 | 359 | 0.40 | 5/1 | B | 5.7 | +1.70 |
| Example 16 | | | | | | | | | | |

What is claimed is:

1. A magnetic recording medium comprising at least a non-magnetic support, a lower non-magnetic layer on one surface of the non-magnetic support, and an upper magnetic layer on the lower non-magnetic layer,
wherein the lower non-magnetic layer contains at least carbon black, a non-magnetic inorganic powder other than carbon black, and a binder resin,
the upper magnetic layer contains at least a ferromagnetic powder and a binder resin containing a polar group, and
the ferromagnetic powder is a ferromagnetic metal powder having an average major axis length of 10 to 50 nm, or a hexagonal ferrite magnetic powder having an average plate diameter of 5 to 40 nm, and
the polar-group-containing binder resin is contained in the upper magnetic layer in such an amount that a proportion of said polar group to unit specific surface area based on the BET method of the ferromagnetic powder is set into a range of 0.18 to 0.35 μmol/m².

2. The magnetic recording medium according to claim 1, wherein the specific surface area based on the BET method of the ferromagnetic powder is from 60 to 100 m²/g.

3. The magnetic recording medium according to claim 1, wherein, in the upper magnetic layer, the polar group of the polar-group-containing binder resin is contained in a proportion of 40 to 150 eq/ton on the basis of the mass of a whole binder resin material in the upper magnetic layer.

4. A process for producing a magnetic recording medium comprising at least a non-magnetic support, a lower non-magnetic layer on one surface of the non-magnetic support, and an upper magnetic layer on the lower non-magnetic layer, the process comprising the steps of:
applying, onto one surface of a non-magnetic support, a non-magnetic layer coating material which contains at least carbon black, a non-magnetic inorganic powder other than carbon black, and a binder resin material, thereby forming a lower non-magnetic layer; and
applying, onto the lower non-magnetic layer, a magnetic layer coating material which contains at least a ferromagnetic powder, and a binder resin containing a polar group, wherein the ferromagnetic powder is a ferromagnetic metal powder having an average major axis length of 10 to 50 nm, or a hexagonal ferrite magnetic powder having an average plate diameter of 5 to 40 nm, and the polar-group-containing binder resin is contained in such an amount that a proportion of said polar group to unit specific surface area based on the BET method of the ferromagnetic powder is set into a range of 0.18 to 0.35 μmol/m², and drying the resultant, thereby forming an upper magnetic layer.
